(19) United States
(12) Patent Application Publication
(10) Pub. No.: US 2026/0296032 A1
(43) Pub. Date: Oct. 1, 2026

(54) PRINTING APPARATUS, CONTROL METHOD THEREFOR, AND NONVOLATILE COMPUTER-READABLE STORAGE MEDIUM

(71) Applicant: CANON KABUSHIKI KAISHA, Tokyo (JP)

(72) Inventors: TAKATOSHI NAKANO, Kanagawa (JP); TSUKASA SANO, Kanagawa (JP); YUTAKA KANO, Kanagawa (JP)

(21) Appl. No.: 19/571,661

(22) Filed: Mar. 19, 2026

(30) Foreign Application Priority Data
Mar. 28, 2025 (JP) 2025-056417

(51) Int. Cl. B41J 2/165

(52) U.S. Cl. CPC B41J 2/16579; B41J 2/16538

(57) ABSTRACT

A printing apparatus, comprising a printhead that executes printing by discharging ink from a discharge surface, a cleaning portion that cleans the discharge surface, and a control portion, wherein the control portion includes a determination unit that determines, for every predetermined time during execution of the printing, for each of regions divided in one direction on the discharge surface, whether the number of times of ink discharge within the predetermined time exceeds a first threshold, a count unit that counts, for each divided region, the number of times the number of times of ink discharge within the predetermined time exceeds the first threshold, and an execution unit that, in a case where a count value of the count unit reaches a second threshold with respect to any of the divided regions, interrupts the printing by the printhead and causes the cleaning portion to execute the cleaning.

### BACKGROUND

### Field of the Technology

The present disclosure relates to a printing apparatus, a control method therefor, and a nonvolatile computer-readable storage medium.

### Description of the Related Art

Some printing apparatuses such as an inkjet printer perform dot counting of measuring the number of times of ink discharge on the ink discharge surface of a printhead and clean the printhead based on the measurement result (see Japanese Patent Laid-Open No. 2019-14175). An example of cleaning is recovery processing for recovering the performance of the printhead, such as wiping of the discharge surface and negative pressure suction for an ink orifice.

When cleaning the printhead during a printing operation, the printing operation is temporarily interrupted. Therefore, to improve the quality and speed of printing, it is preferable to perform proper cleaning.

### SUMMARY

The present disclosure provides a technique advantageous in improving both the quality and speed of printing.

One of the aspects of the present disclosure provides a printing apparatus, comprising: a printhead configured to execute printing by discharging ink from a discharge surface; a cleaning portion configured to clean the discharge surface; and a control portion, wherein the control portion includes a determination unit configured to determine, for every predetermined time during execution of the printing by the printhead, for each of a plurality of regions divided in one direction on the discharge surface, whether the number of times of ink discharge within the predetermined time exceeds a first threshold, a count unit configured to count, for each of the plurality of divided regions, the number of times the number of times of ink discharge within the predetermined time exceeds the first threshold, and an execution unit configured to, in a case where a count value of the count unit reaches a second threshold with respect to any of the plurality of divided regions, interrupt the printing by the printhead and cause the cleaning portion to execute the cleaning.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view showing an example of the configuration of a printing apparatus according to an embodiment.

FIG. 2 is a block diagram showing an example of the configuration of a control system of the printing apparatus.

FIG. 3 is a schematic view showing the ink discharge surface of a printhead.

FIG. 4A is a schematic view showing an example of the configuration of a printing element board.

FIG. 4B is a schematic view showing the example of the configuration of the printing element board.

FIG. 4C is a schematic view showing the example of the configuration of the printing element board.

FIG. 5 is a schematic sectional view for explaining an example of the internal structure of the printing element board.

FIG. 6A is a schematic view for explaining an example of the contents of temperature adjustment control of the printing element board.

FIG. 6B is a schematic view for explaining the example of the contents of temperature adjustment control of the printing element board.

FIG. 7A is a schematic view for explaining condensation that may be generated on the printing element board.

FIG. 7B is a schematic view for explaining condensation that may be generated on the printing element board.

FIG. 8A is a view showing an example of a determination method based on dot counting.

FIG. 8B is a flowchart illustrating the example of the determination method based on dot counting.

FIG. 8C is a view showing the example of the determination method based on dot counting.

FIG. 9A is a flowchart illustrating an example of a method of determining whether it is necessary to execute cleaning.

FIG. 9B is a view showing the example of the method of determining whether it is necessary to execute cleaning.

FIG. 10A is a view showing another example of a determination method based on dot counting.

FIG. 10B is a flowchart illustrating the other example of the determination method based on dot counting.

FIG. 11A is a flowchart illustrating an example of a determination method for condensation.

FIG. 11B is a view showing the example of the determination method for condensation.

FIG. 12A is a flowchart illustrating another example of a method of determining whether it is necessary to execute cleaning.

FIG. 12B is a view showing the other example of the method of determining whether it is necessary to execute cleaning.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

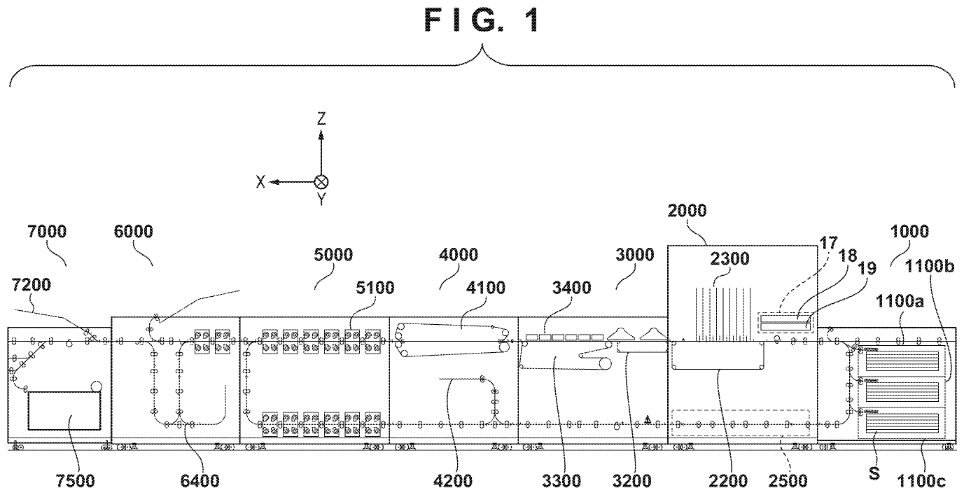

FIG. 1 is a schematic view showing an example of the configuration of a printing apparatus (to be referred to as this printing apparatus hereinafter) according to the embodiment. This printing apparatus can be configured to implement printing by discharging a liquid. Examples of the liquid are ink and a reaction liquid.

Printing in this specification indicates forming an image by discharging a liquid onto a print medium S, and the concept of an image includes a character, a number, a symbol, a graphic, and a photograph regardless of whether the image is visible. The ink is typically a liquid containing dye or pigment, and the reaction liquid is a liquid for fixing the ink onto the print medium S. From this viewpoint, this printing apparatus may be expressed as a liquid discharge apparatus. Note that this printing apparatus may be a copying machine having a print function as a main function and further having, as sub-functions, additional functions such as a copy function, a scanner function, and a facsimile function.

The above-described printing method is called an inkjet method. Although a line head is used as the printhead for executing printing in this embodiment, a serial head may be used in another embodiment. This printing apparatus may be a sheet-fed type apparatus that executes printing on a cut sheet as the print medium S or may be a roll-fed type apparatus that executes printing on a roll sheet.

In FIG. 1, a direction from the right side to the left side is defined as a longitudinal direction, and the print medium S is mainly conveyed in the longitudinal direction. In addition, a direction from the near side (the front side of the apparatus) to the far side (the rear side of the apparatus) is defined as the widthwise direction of the print medium S, and this direction is substantially orthogonal to the longitudinal direction.

This printing apparatus includes a feeding module 1000, a print module 2000, a drying module 3000, a fixing module 4000, a cooling module 5000, an inverting module 6000, and a discharged paper stacking module 7000. The print medium S (in this example, a cut sheet) supplied from the feeding module 1000 is conveyed along a predetermined path by a conveyance mechanism in each subsequent module, and discharged to the discharged paper stacking module 7000 after undergoing corresponding processing in each subsequent module.

The feeding module 1000 includes storages 1100a to 1100c each storing the print medium S. For example, each of the storages 1100a to 1100c is configured to be drawn to the front side of the apparatus, and can be set or replenished with the print medium S. The print medium S is supplied one by one by a separation belt and a conveyance roller in each of the storages 1100a to 1100c, and conveyed to the print module 2000. Note that the number of storages 1100a and the like is not limited to this example.

The print module 2000 includes a print belt unit 2200 and a printing portion 2300 in addition to a registration correction portion (not shown). The print medium S conveyed from the feeding module 1000 undergoes correction of its posture (tilt) and position by the registration correction portion, and is conveyed to the print belt unit 2200. The printing portion 2300 is arranged at a position facing the print belt unit 2200 with respect to the conveyance path of the print medium S. The printing portion 2300 includes a printhead that is a line head, and executes printing by the printhead on the conveyed print medium S from above. At this time, the print medium S is attracted and conveyed by the print belt unit 2200, thereby making it possible to ensure a distance from the printhead.

In the printing portion 2300, a plurality of printheads that are line heads are juxtaposed in the conveyance direction. This embodiment assumes that five printheads that can individually discharge five types of liquids in total including four color inks of yellow (Y), magenta (M), cyan (C), and black (Bk) and a reaction liquid (P) are juxtaposed. Alternatively, the reaction liquid may be included in the broad concept of ink.

Note that for printing using the inkjet method, a method using a heater element (electrothermal transducer) is employed in this embodiment. As another embodiment, a known method such as a method using a piezoelectric element, a method using an electrostatic element, or a method using a MEMS element may be employed. Each of various types of liquids is supplied from each liquid storage portion (not shown) to a corresponding printhead via a tube.

This embodiment can be described below by focusing on an arbitrary color ink. The same applies to the remaining liquids.

The print medium S printed by the printing portion 2300 is conveyed by the print belt unit 2200, and can be read/detected by an inline scanner (not shown) arranged on the downstream side of the printing portion 2300 in the conveyance direction. This can correct the printing operation based on, for example, the deviation of the position or color density of an image formed on the print medium S.

The drying module 3000 includes a decoupling portion 3200, a drying belt unit 3300, and a warm air blowing portion 3400, and can fix ink onto the print medium S by evaporating moisture on the print medium S printed by the printing portion 2300. The printed print medium S is conveyed to the decoupling portion 3200 in the drying module 3000. In the decoupling portion 3200, the print medium S on the belt can be conveyed while being held by friction of the belt and wind pressure from above the belt, thereby preventing the deviation of the position of the print medium S. The print medium S conveyed from the decoupling portion 3200 is attracted and conveyed by the drying belt unit 3300, and hot air is sent from the warm air blowing portion 3400 arranged above the drying belt unit 3300, thereby making it possible to dry the surface (the surface to which ink is discharged) of the print medium S.

Note that the drying method is not limited to the method of sending hot air, and a method of irradiating the surface of the print medium S with an electromagnetic wave (ultraviolet rays, infrared rays, or the like), a heat conduction method by contact of a heat generating body, or a combination of the known methods may be employed.

The fixing module 4000 includes a fixing belt unit 4100. The fixing belt unit 4100 is configured so that the print medium S passes through a portion between a heated upper belt unit and a lower belt unit, and fixes ink onto the print medium S conveyed from the drying module 3000.

The cooling module 5000 includes a plurality of cooling portions 5100, thereby making it possible to cool the print medium S in a high-temperature state conveyed from the fixing module 4000. Each cooling portion 5100 increases the internal pressure by taking outside air by a predetermined fan, and applies cool air from a predetermined blowing port formed in a conveyance guide to the print medium S, thereby cooling the print medium S. The plurality of cooling portions 5100 are arranged on two sides (upper side and lower side) of the conveyance path of the print medium S, and arranged so as to cool the print medium S from the two sides.

In addition, the cooling module 5000 incorporates a conveyance path switching portion that can switch the conveyance path of the print medium S, and can switch the conveyance path between a case where the print medium S is conveyed to the inverting module 6000 and a case where double-sided printing is executed. In a case where double-sided printing is executed, the print medium S passes through the conveyance path below the cooling module 5000, and is further conveyed along the conveyance path for double-sided printing of the fixing module 4000, the drying module 3000, the print module 2000, and the feeding module 1000. The fixing module 4000 incorporates a first inverting portion 4200 that inverts the print medium S, and is thus configured to invert the print medium S and return it to the print module 2000, thereby further executing printing on the inverted print medium S.

The inverting module 6000 includes a second inverting portion 6400, and can thus invert the print medium S conveyed from the cooling module 5000 and convey it to the discharged paper stacking module 7000. In this way, the direction (which of the front surface and the back surface is set to face up or down) of the print medium S discharged from the discharged paper stacking module 7000 can freely be changed.

The discharged paper stacking module 7000 includes a top tray 7200 and a stacking portion 7500, and aligns and stacks the print medium S conveyed from the inverting module 6000.

The print module 2000 incorporates a cleaning portion 17, and can recover the print performance of the printhead by performing predetermined cleaning. The cleaning portion 17 can include, for example, a cap mechanism that caps the ink discharge surface (orifice surface) of the printhead to protect it, a wiper mechanism that wipes the discharge surface, and a suction mechanism that sucks ink in the printhead by a negative pressure from the discharge surface. In this example, wiping and negative pressure suction are collectively expressed as cleaning, but another known recovery process may additionally/alternatively be employed.

Note that a driving mechanism and a rail (neither of which is shown) are provided in the cleaning portion 17, and can be used to reciprocally move the cleaning portion 17 in the horizontal direction. For example, the cleaning portion 17 moves to a position immediately below the printhead when executing cleaning, and retreats from the position immediately below the printhead when executing no cleaning.

(Control System of this Printing Apparatus)

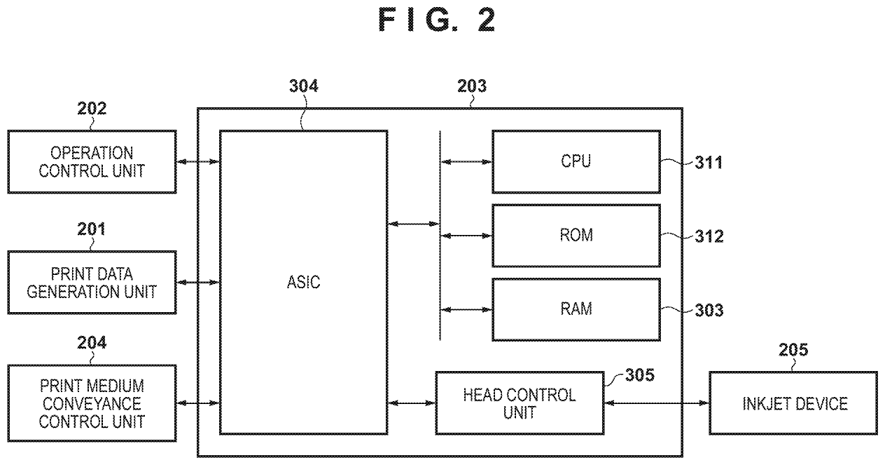

FIG. 2 is a functional block diagram in which control of the entire system of this printing apparatus can be implemented. This printing apparatus includes a print data generation unit 201, an operation control unit 202, a printer control unit 203, a print medium conveyance control unit 204, and an inkjet device 205.

The print data generation unit 201 is a module that generates print data. The generated print data is output to the printer control unit 203. Note that the print data generation unit 201 may be provided outside this printing apparatus (for example, in an external print server or the like).

The operation control unit 202 is configured to accept an operation input (instruction) from a user. The operation control unit 202 is an operation panel provided in this printing apparatus in this embodiment, but may be a terminal (for example, a keyboard, a mouse, or a personal computer to which it/these are connected) externally connected to this printing apparatus in another embodiment. Note that the user may typically be the owner or administrator of this printing apparatus, but may be the provider of this printing apparatus and may be, for example, a repairer.

The print medium conveyance control unit 204 controls conveyance of the print medium S. The inkjet device 205 controls printing by the printhead.

The printer control unit 203 includes a Central Processing Unit (CPU) 311, a Read Only Memory (ROM) 3122, a Random Access Memory (RAM) 303, an Application Specific Integrated Circuit (ASIC) 304, and a head control unit 305. The CPU 311 reads out various kinds of programs from the ROM 312, deploys them in the RAM 303, and executes them, thereby performing calculation processing necessary to implement printing by this printing apparatus. The ASIC 304 includes a network controller, a serial IF controller, a head data generation controller, and a motor controller. The head control unit 305 generates discharge data to be used by the inkjet device 205, and also controls driving of the heater element, driving of a sub heater (to be described later), and the like.

### (Printhead Configuration)

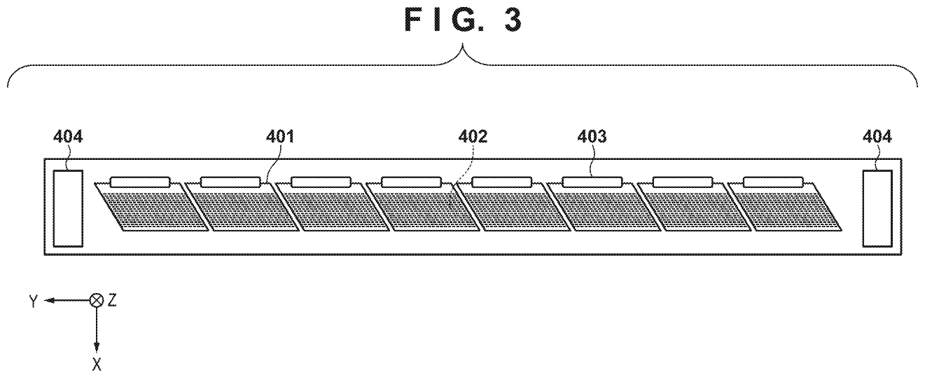

FIG. 3 is a schematic view showing the ink discharge surface of the printhead. On the discharge surface of the printhead, a plurality of printing element boards 401 are arrayed in the widthwise direction (Y direction) of the print medium S. On each printing element board 401, a plurality of orifices 402 for discharging ink are arrayed in the conveyance direction (X direction) and widthwise direction (Y direction) of the print medium S.

A positioning member 404 of the printhead is provided on each side of the plurality of printing element boards 401 in the array direction. For example, by engaging the positioning member 404 at a predetermined position in this printing apparatus, it is possible to define the distance between the discharge surface of the printhead and the print belt unit 2200. On each printing element board 401, a sealing material 403 is provided to protect a connection terminal portion.

Among the plurality of arrayed orifices 402, one array of orifices arranged in the widthwise direction (Y direction) of the print medium S can be expressed as an “orifice array”, and 16 arrays are arranged in this example. Each orifice array is formed by arraying 512 orifices 402 at an interval of 600 dots per inch (dpi). The 16 orifice arrays are arranged at different positions in the X direction, and two orifice arrays adjacent to each other in the X direction are arranged to be shifted in the Y direction by 1,200 dpi.

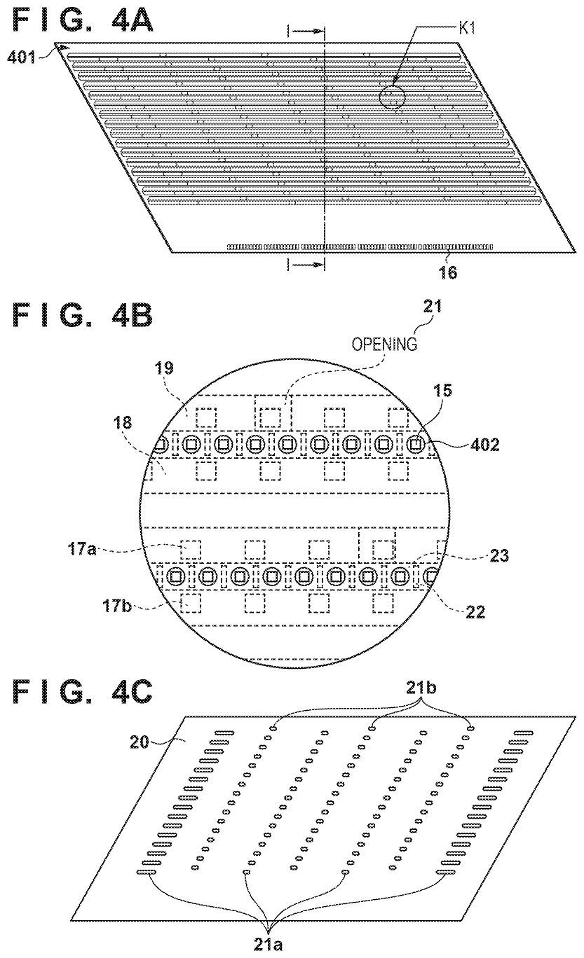

FIG. 4A is a schematic view of the front surface side (ink discharge side) of one printing element board 401, FIG. 4B is a partially enlarged view of a region K1, and FIG. 4C is a schematic view of the back surface side of the printing element board 401.

As shown in FIG. 4B, a printing element 15 as a heater element is arranged at a position corresponding to each orifice 402, and a pressure chamber 23 is partitioned by partitions 22 to include this printing element 15. The printing element 15 is electrically connected to a terminal 16 by an electric wiring (not shown) provided in the printing element board 401, and generates heat based on a pulse signal input via the electric wiring to foam ink, thereby discharging the ink from the orifice 402.

As shown in FIG. 4B, on one side of each orifice array, a liquid supply path 18 extends along the orifice array. On the other side of the orifice array, a liquid recovery path 19 extends along the orifice array. The liquid supply path 18 communicates with the orifice 402 via a supply port 17a, and the liquid recovery path 19 communicates with the orifice 402 via a recovery port 17b. These form an ink circulation channel.

As shown in FIG. 4C, on the back surface side (the opposite side of the surface on which the orifices 402 are formed) of the printing element board 401, a cover plate 20 in which openings 21a and 21b that communicate with the liquid supply path 18 and the liquid recovery path 19 are formed is arranged. Note that in this example, four supply openings 21a are formed for one liquid supply path 18 and three recovery openings 21b are formed for one liquid recovery path 19, but the number of supply openings and the number of recovery openings are not limited to this example.

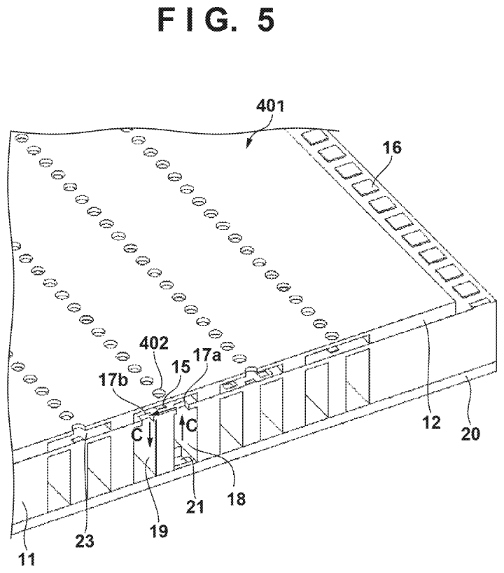

FIG. 5 is a schematic sectional view taken along a cut line I-I in FIG. 4A. The liquid supply path 18 and the liquid recovery path 19 are formed in a semiconductor substrate 11 (typically, a silicon substrate) as the base material of the printing element board 401, and the cover plate 20 functions as a lid portion or a part of a wall portion forming the liquid supply path 18 and the liquid recovery path 19. On the surface of the printing element board 401 on the opposite side of the cover plate 20, an orifice forming member 12 having the above-described orifices 402, supply ports 17a, and recovery ports 17b is arranged. The orifice forming member 12 is typically made of a photosensitive resin.

As is apparent from FIG. 5, the printing element 15 is formed on one surface of the semiconductor substrate 11, and the liquid supply path 18 and the liquid recovery path 19 are formed on the other surface to extend along the orifice array. The liquid supply path 18 and the liquid recovery path 19 are respectively connected to a common supply channel and a common recovery channel (neither of which is shown), and a pressure difference is generated between the liquid supply path 18 and the liquid recovery path 19. With this pressure difference, the ink in the liquid supply path 18 flows to the liquid recovery path 19 by passing through the supply port 17a, the pressure chamber 23, and the recovery port 17b, as indicated by arrows C.

With the above configuration, thickened ink, a bubble, and a foreign substance that can be generated in the orifice 402 and the pressure chamber 23 by evaporation from the orifice 402 can be recovered to the liquid recovery path 19, thereby preventing deterioration in printing quality.

The ink recovered to the liquid recovery path 19 is recovered to a buffer tank (not shown) by passing through the common recovery channel, pumped by a pump (not shown) from the buffer tank to pass through the common supply channel, and then supplied again to the liquid supply path 18. In this way, the ink can circulate. In this circulation system, for example, a heat exchanger (not shown) can be installed in any portion of the common supply channel, and the ink supplied to the liquid supply path 18 can be maintained at a predetermined temperature (for example, 25° C.).

### (Temperature Adjustment Control of Printing Element Board)

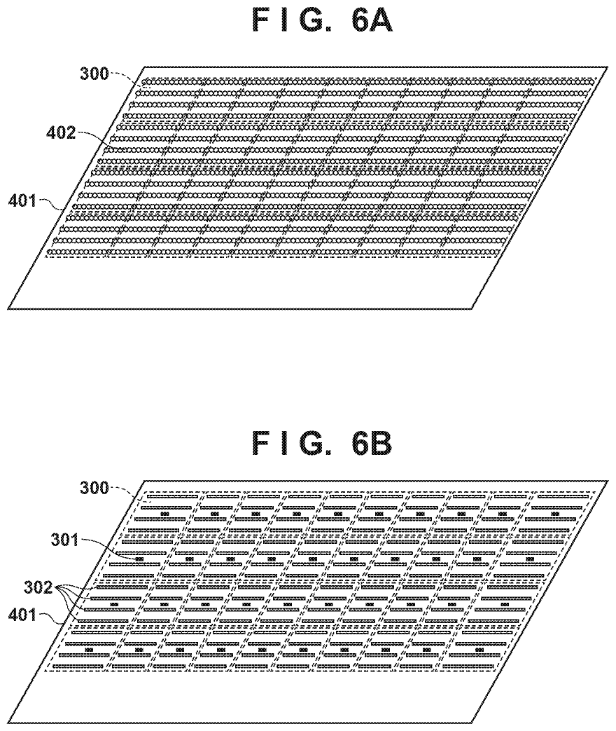

As shown in FIGS. 6A and 6B, each printing element board 401 is partitioned into a plurality of temperature-adjusted areas 300 for temperature adjustment, and is partitioned into 40 areas 300 of 10 rows×4 columns in this embodiment. In each area 300, a temperature sensor 301 and sub heaters 302 are provided, and the control unit 203 (see FIG. 2) performs temperature adjustment for each area 300 by individually driving the sub heaters 302 with reference to the detection result of the temperature sensor 301. That is, the sub heaters 302 are driven in the area 300 where the detected temperature (detection value, output value, or signal value) by the temperature sensor 301 is equal to or lower than a target temperature.

Driving energy for driving the sub heaters 302 is adjusted based on the difference between the target temperature and the detected temperature of the temperature sensor 301. This can maintain the viscosity of the ink, and make the discharge amount of the ink constant.

In addition to prevention of density unevenness (deterioration in printing quality) of an image caused by the temperature variation of the printing element board 401, temperature adjustment contributes to proper implementation of ink circulation. Therefore, when the temperature of the ink becomes low, the viscosity increases to make it difficult for the ink to circulate, and thus the lower limit value (for example, 38.0° C.) can be set as an initial value for the target temperature of the printing element board 401.

The temperature variation of the printing element board 401 is mainly caused by differences in temperature rise characteristic or heat radiation characteristic among the areas 300. Therefore, if the printing duty (the number of times of printing (the number of times of ink discharge) per unit time) increases, the temperature variation may become large. The temperature variation can be more conspicuous in a configuration in which the ink always flows on the printing element board 401 due to ink circulation.

In this embodiment, during execution of printing, the target temperature of the printing element board 401 is periodically reset (updated) so that the temperature variation falls within an allowable range by feeding back the detection result of the temperature sensor 301 of each area 300.

For example, during execution of printing, the temperature of each area 300 is acquired by the temperature sensor 301 and the temperature distribution on the printing element board 401 is specified. Next, for example, a temperature 2° C. lower than the maximum value (maximum temperature) of the acquired detected temperatures at 40 locations is reset to the target temperature of the printing element board 401. Thus, the relatively low-temperature area 300 whose temperature is at least 2° C. lower than the maximum temperature of the areas 300 is selectively heated by the sub heaters 302.

On the other hand, in the relatively high-temperature area 300 whose temperature is higher than the reset target temperature, heating by the sub heaters 302 is suppressed. Therefore, the temperature variation of the printing element board 401 is suppressed within 2° C. Note that when the maximum temperature decreases, the reset target temperature accordingly decreases, and thus the target temperature remains at the lower limit value (for example, 38.0° C.) in a case where the temperature of the printing element board 401 does not vary.

Such temperature adjustment is executed by an interrupt job at a period of 25 milliseconds (msec) during execution of printing, thereby making it possible to suppress a temperature variation that may occur on the printing element board 401 during execution of printing.

As an example, if a printing duty is relatively low (for example, 50% or less), the heat generation amount of the printing element board 401 is relatively small, and the amount of supplied ink is also small. Therefore, the temperature does not substantially vary, and the target temperature of the printing element board 401 remains at the lower limit value (for example, 38.0° C.).

To the contrary, if the printing duty is relatively high (for example, 100%), the heat generation amount of the printing element board 401 is relatively large, and the amount of supplied ink is also large. In this case, since the temperature variation is large (for example, a temperature variation of 4° C. or more occurs at the maximum temperature of 44.0° C. of the printing element board 401), the above-described temperature adjustment needs to be executed. Note that when temperature adjustment is executed at the relatively high printing duty, a temperature variation can be suppressed within 2° C. at the maximum temperature of 42° C.

As another example, in a case where the printing duty in one half region of the printing element board 401 is 100% and the printing duty in the other half region is 0%, the temperature variation of the printing element board 401 may become larger. In this case as well, the temperature variation can be suppressed within 2° C. by executing the above-described temperature adjustment.

As described above, the target temperature of the printing element board 401 is reset by feeding back the detection result of the temperature sensor 301. That is, temperature adjustment control according to this embodiment is feedback control based on the detection result of the temperature sensor 301. Therefore, the effect of temperature adjustment can stably be implemented (regardless of a variation in heat energy of the printing element 15, a variation in circulation flow velocity of the ink, or the like), thereby appropriately improving printing quality.

Since silicon having a relatively high thermal conductivity can typically be used for the printing element board 401, if the target temperature of the printing element board 401 is set to an unnecessarily high value, the maximum temperature of the printing element board 401 may become high due to heat transfer between the adjacent areas 300. In this case, the reset target temperature becomes high and control may become unstable.

A known change or modification may be applied to the above configuration without departing from the scope of this embodiment. For example, the same configuration as that of the heater element that is the printing element 15 may be applied to the sub heater 302, but another heating means may be used. A diode sensor can typically be used as the temperature sensor 301, but another temperature measurement means may be used.

### (Condensation Generated on Discharge Surface)

When the relatively high printing duty is continued, condensation may be generated on the discharge surface of the printhead, thereby deteriorating printing quality.

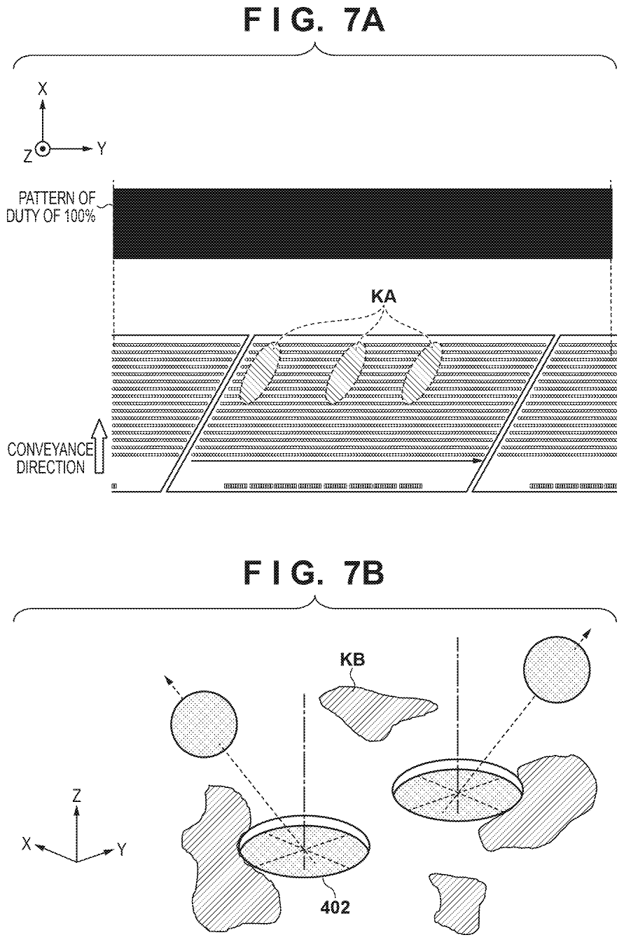

FIG. 7A is a schematic view of a print pattern of a printing duty of 100% and a given printing element board 401 that continuously (for example, for about 3 hours) prints the print pattern. That is, an image of a printing duty of 100% is assigned to the entire region of the printing element board 401. Note that at a printing duty of 100%, ink of an amount of 7 grams/square meter (g/m²) is discharged to the print medium S (to be referred to as “high-duty printing” hereinafter for the sake of descriptive simplicity) (note that a relatively low printing duty will be referred to as “low-duty printing” hereinafter).

In a case of high-duty printing, both an amount of ink discharged from the discharge surface and an amount of ink applied to the surface of the print medium S are large. Therefore, the humidity in a space (a gap of about 1 millimeter (mm)) between the discharge surface and the surface of the print medium S is substantially 100% due to moisture evaporated from these surfaces.

In a case of high-duty printing, since the number of times of printing (the number of times of ink discharge) of the printing element 15 per unit time is large, the temperature of the printing element board 401 increases up to, for example, about 42° C. The saturation water vapor amount in the space between the discharge surface and the surface of the print medium S becomes large and the water content in the space thus becomes large.

In the space between the discharge surface and the surface of the print medium S, an air flow in the +X direction occurs due to conveyance of the print medium S in the +X direction (a conveyance speed of 0.7 millimeters/second (mm/sec)). This air flow depends on a Couette flow (a flow in a flow layer, which occurs between two parallel plates when one of the plates moves). The flow velocity can be given by:

u(y)=U/h*y
U: the moving speed of one plate (moving plate)
h: the distance between the two plates
y: the distance from the other plate (fixed plate)

In this embodiment, in theory, the flow velocity near the surface of the print medium S is 0.7 m/sec (y=h) and the flow velocity near the discharge surface is 0 m/sec (y=0). Therefore, air with 100% humidity readily stays near the discharge surface. If the temperature decreases along with conveyance of the print medium S and the saturation water vapor amount becomes small, water droplets are generated from air with 100% humidity staying near the discharge surface, thereby causing condensation on the discharge surface. This condensation is generated in a relatively low-temperature portion when the temperature distribution of the discharge surface is not uniform.

In this embodiment, by earnest examinations of the present inventor, it becomes apparent that condensation is readily generated in a region KA shown in FIG. 7A, and is readily generated near the supply opening 21a through which ink whose temperature is maintained by a heat exchanger (for example, 25° C.) flows.

FIG. 7B is a schematic view for explaining a mechanism in which printing quality deteriorates when condensation is generated. Water droplets generated by condensation on the discharge surface of the printing element board 401 are gradually combined with each other, thereby forming a relatively wide wet region KB. In a case where the wet region KB is formed near the orifice 402, this changes the discharge direction of the ink to change a landing position on the print medium S, thereby deteriorating printing quality.

Therefore, if high-duty printing continues, it is necessary to temporarily interrupt the printing operation and perform cleaning to remove condensation on the discharge surface. On the other hand, if low-duty printing continues, condensation is hardly generated, and thus it is substantially unnecessary to perform cleaning to remove condensation.

### (Details of Cleaning Execution Condition)

In general, foreign substances (for example, paper powder) from the print medium S or foreign substances (for example, floating ink mist) in air may attach to the printhead. Therefore, when a parameter indicating the degree of continuity of the printing operation reaches a standard, cleaning is performed. Examples of the parameter are, for example, a continuous printing time, the number of continuously printed sheets, and the number of times of continuous printing.

As an example, assume that when the continuous printing time exceeds 3 hours, cleaning is executed. However, when high-duty printing continues for, for example, 1 hour or more, condensation is generated, and thus cleaning is executed before that in this embodiment.

Continuation of high-duty printing can be detected or specified by dot counting of measuring the number of times of printing (the number of times of ink discharge) of the printing element 15 within a predetermined period, and the measurement value is expressed as a dot count value.

As an example, a case where printing at a printing duty of 50% is executed for 10 min and a case where printing at a printing duty of 100% is executed for 5 min after executing printing at a printing duty of 0% for 5 min are not always equivalent to each other. The reason for this is that no condensation is generated in the former case and condensation may be generated in the latter case.

Therefore, dot counting needs to be performed not within a total required time from the start to the end of the printing operation but within a time divided by a relatively short period.

Since air between the ink discharge surface and the surface of the print medium S is also diffused in the Y direction, ease of generation of condensation generally depends on the size of the print pattern in the Y direction.

For example, if the region of high-duty printing is relatively small (for example, the region is half the size of the printing element board 401 in the Y direction or smaller), condensation is hardly generated. To the contrary, if the region of high-duty printing is relatively large (for example, the region is half the size of the printing element board 401 in the Y direction or larger), air with 100% humidity is not diffused sufficiently in the Y direction, and thus condensation is readily generated.

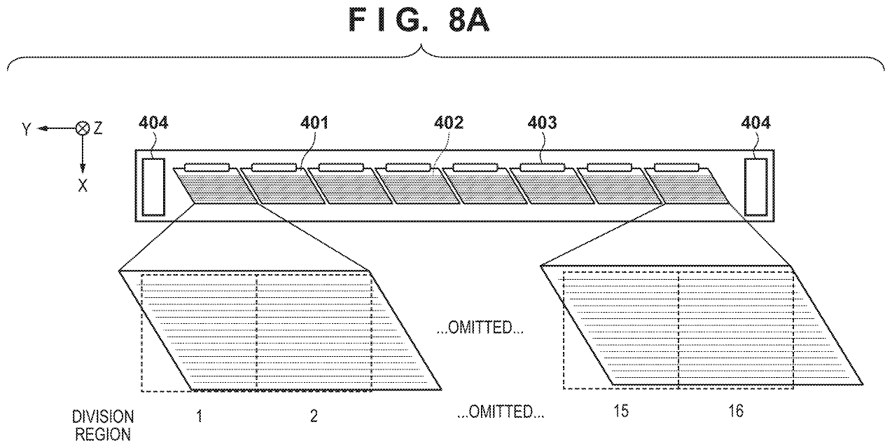

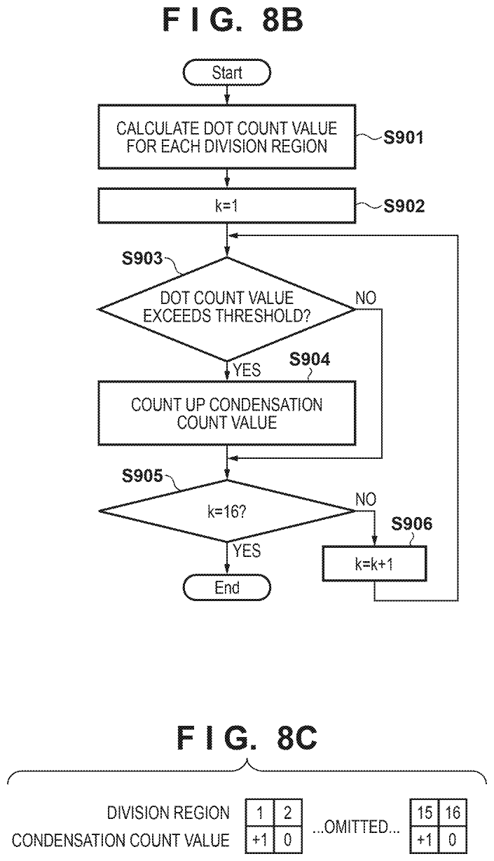

Therefore, dot counting is performed for each of a plurality of regions divided in the Y direction on the printing element board 401. This embodiment assumes that each of eight printing element boards 401 is divided into two regions in the Y direction (16 regions in total), as shown in FIG. 8A, and dot counting is performed for each region. For the sake of descriptive simplicity, the divided region will be referred to as a “division region” hereinafter.

FIG. 8B is a flowchart illustrating an example of a dot counting execution method. Each step(S) exemplified in this flowchart can be performed when mainly the CPU 311 reads out a predetermined program from the ROM 312, deploys it in the RAM 303, and executes it.

In S901, a dot count value for a predetermined time (1 min in this example) is calculated for each division region.

In S902, a division region as a determination target (to be described later) is set as a kth division region (k=integer of 1 to 16), and k=1 is set, that is, the first division region is selected.

In S903, it is determined whether the dot count value of each division region exceeds a predetermined threshold (1.7×10⁸ in this example). This threshold is a dot count value with which it can be determined that condensation is generated, and is specified in advance based on a predetermined experiment or evaluation. If the dot count value exceeds the threshold, the process advances to S904; otherwise, the process advances to S905.

In S904 (if the dot count value exceeds the threshold), a condensation count value set for the kth division region is counted up. Details of the condensation count value will be described later.

In S905, it is determined whether k=16, that is, it is determined whether S903 and S904 have been performed for all of the first to 16th division regions. If k=16, this flowchart ends; otherwise, the process advances to S906.

In S906, k=k+1 is set (k is incremented), that is, the next division region is selected. Then, the process returns to S903.

FIG. 8C shows, as an example, the condensation count value in a case where the dot count value exceeds the threshold with respect to the first and 15th division regions among the first to 16th division regions. The condensation count value is set to 0 as an initial value, and is counted up when the dot count value exceeds the threshold (YES is determined in S903). Although further details will be described later, when the condensation count value reaches another threshold, it is determined that condensation may be generated, and the above-described cleaning is executed.

Note that the measurement in S904 may be expressed as condensation counting, condensation warning counting, condensation risk counting, or the like.

The above-described dot counting and condensation counting (S901 to S906) are executed for every predetermined time (in this example, every minute) during a period from the start to the end of the printing operation.

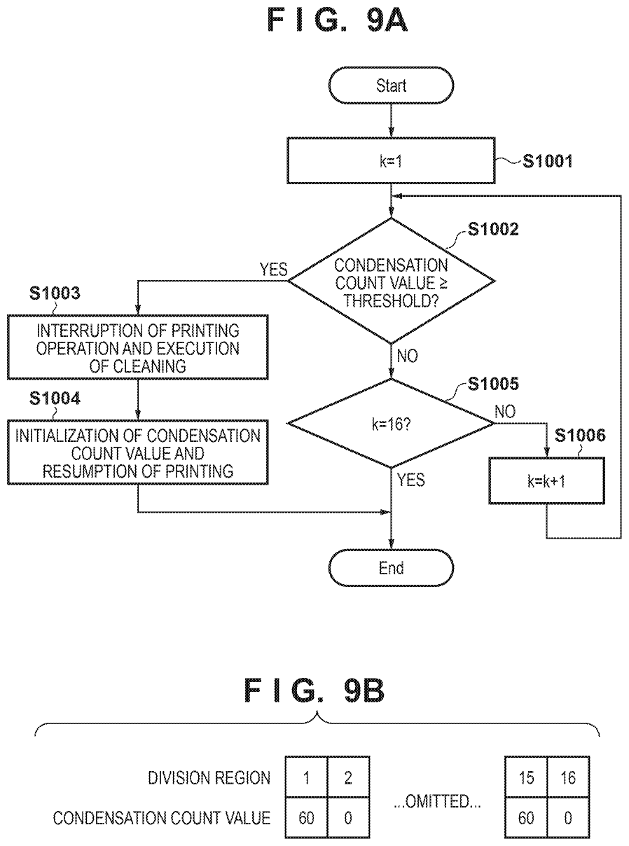

FIG. 9A is a flowchart illustrating an example of a method of determining whether it is necessary to execute cleaning. FIG. 9B shows, as an example, the condensation count value in a case where printing in which the dot count value exceeds the threshold is continued for 60 min for each of the first and 15th division regions, in which the condensation count value is 60.

In S1001, k=1 is set, that is, the first division region is selected as a determination target.

In S1002, it is determined whether the condensation count value counted up in S901 to S906 is equal to or larger than the threshold (in this example, 60). If the condensation count value is equal to or larger than the threshold, the process advances to S1003; otherwise, the process advances to S1005.

In S1003, the printing operation is interrupted, and cleaning of the discharge surface of the printhead is executed. In this embodiment, with respect to the first division region (k=1), since the condensation count value is 60, as shown in FIG. 9B, YES is determined in S1002 and thus cleaning is executed.

After completion of the cleaning, in S1004, all of the condensation count values are initialized (reset to 0), and the interrupted printing operation is resumed. After that, the above-described dot counting and condensation counting (S901 to S906) are executed for every predetermined time (in this example, every minute).

In S1005, it is determined whether k=16, that is, it is determined whether S1002 has been performed for all of the first to 16th division regions. If k=16, this flowchart ends; otherwise, the process advances to S1006.

In S1006, k=k+1 is set (k is incremented), that is, the next division region is selected. Then, the process returns to S1002.

That is, cleaning according to this embodiment is executed when the condensation count value is equal to or larger than the threshold (in this example, 60) with respect to at least one of the first to 16th division regions, and is not executed when the condensation count value is smaller than the threshold with respect to all of the first to 16th division regions.

In this embodiment, since cleaning is executed by assuming that condensation may be generated when high-duty printing is continued for 60 min, and dot counting is performed every minute, 60 is set as the threshold for condensation counting. Therefore, if it is assumed that condensation may be generated when high-duty printing is continued for 90 min, 90 is set as the threshold for condensation counting.

It is considered a case where condensation is hardly generated when high-duty printing is intermittently performed (low-duty printing is inserted). Therefore, if the condensation count value is not counted up continuously, the condensation count value may be initialized. Alternatively, if the condensation count value is not counted up continuously, the condensation count value may be decreased in accordance with the corresponding number of times.

According to this embodiment, when high-duty printing is performed continuously, cleaning is executed before condensation is generated on the discharge surface due to high-duty printing, and thus it is possible to appropriately maintain printing quality. According to this embodiment, since cleaning is not performed excessively and the printing operation is not unnecessarily interrupted, the downtime of this printing apparatus can be reduced. Therefore, this embodiment is advantageous in improving both the quality and speed of printing.

### Second Embodiment

The first embodiment has exemplified the form in which the printing element board 401 is divided into two regions in the Y direction and dot counting and condensation counting are performed, but the present disclosure is not limited to this. For example, in a case where the region of high-duty printing is relatively large (for example, the region is half the size of the printing element board 401 in the Y direction or larger), when the region is located across the first and second division regions, the condensation count value is never equal to or larger than the threshold for either of the division regions. Therefore, it may be required to change the region division form.

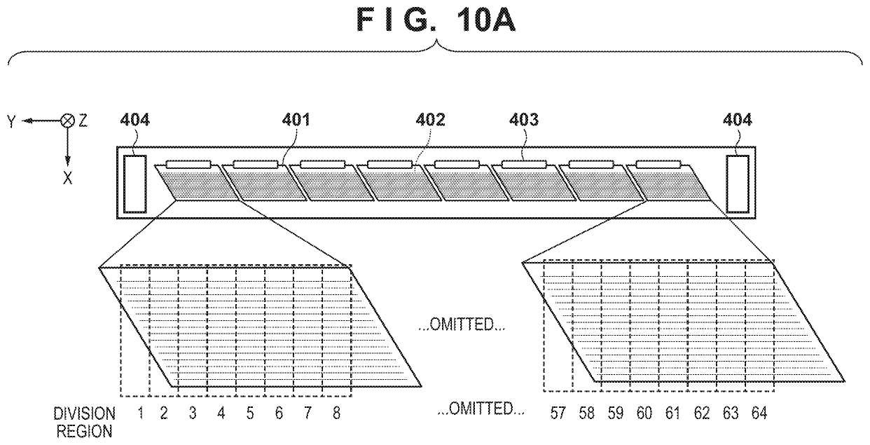

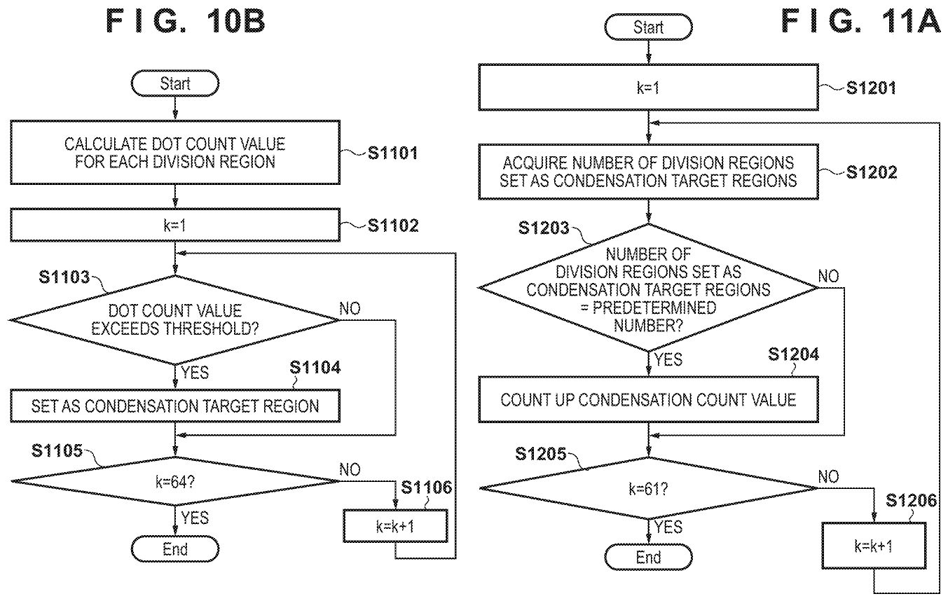

FIG. 10A shows a schematic view in a case where the division number of a printing element board 401 in the Y direction is 8, as in FIG. 8A of the first embodiment. Therefore, in this embodiment, each of eight printing element boards 401 is divided into eight regions in the Y direction (64 regions in total), and dot counting is performed for each region.

FIG. 10B shows a flowchart of dot counting according to this embodiment, as in FIG. 8B of the first embodiment. Assume that S1101, S1102, S1103, and S1106 of this flowchart are the same as S901, S902, S903, and S906 of FIG. 8B, respectively.

In S1104 (if the threshold is exceeded), a kth division region is set as a condensation target region (to be described later). This setting is used to determine whether it is necessary to execute cleaning according to this embodiment, and this embodiment is mainly different from the first embodiment in terms of this point.

In S1105, it is determined whether k=64, that is, it is determined whether S1103 and S1104 have been performed for all of the first to 64th division regions. If k=64, this flowchart ends; otherwise, the process advances to S1106.

As described above, there is air with 100% humidity between an ink discharge surface and the surface of a print medium S, and condensation is readily generated when air is not sufficiently diffused in the Y direction and is hardly generated when air is sufficiently diffused in the Y direction. Thus, when focusing on only one division region set as the condensation target region, the setting of the condensation target region in S1104 can be said as a flag indicating that one of conditions for generation of condensation is satisfied in the division region. That is, even if there exist one or more division regions set as condensation target regions, when the one or more condensation target regions are not locally located (for example, adjacent division regions are not condensation target regions), it can be said that condensation is hardly generated.

Therefore, in this embodiment in which the division number is increased, there is a need to determine whether the plurality of condensation target regions set in S1104 exist continuously/locally in the Y direction. From this viewpoint, the condensation target region may be expressed as a condensation warning target region, a condensation risk target region, or the like.

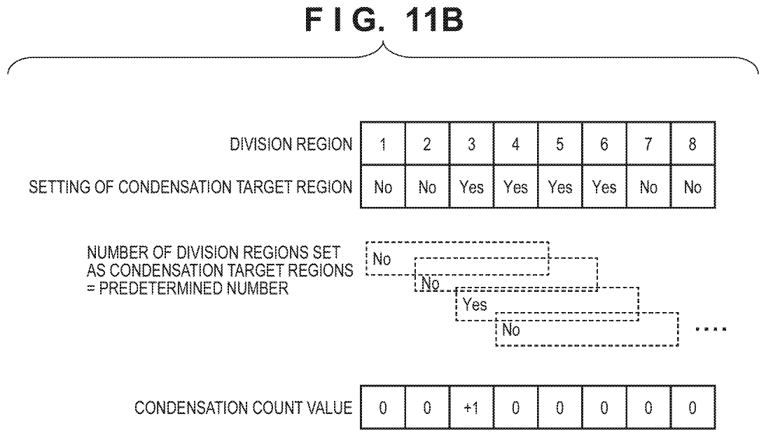

FIG. 11A is a flowchart illustrating an example of a determination method for condensation in the division regions set as the condensation target regions. FIG. 11B shows an example of a condensation target region setting result. In this example, among the first to eighth division regions, the third to sixth division regions are set as condensation target regions (which are indicated by “Yes” in FIG. 11B). That is, this example shows a case where YES is determined in S1103 for k=3 to 6 in the flowchart of FIG. 10B. Note that the remaining division regions are not set as condensation target regions (which are indicated by “No” in FIG. 11B).

In S1201, k=1 is set, that is, the first division region is selected as a determination target.

In S1202, with respect to a predetermined number (in this example, four) of continuous division regions, the number of division regions set as condensation target regions is acquired.

In S1203, it is determined whether the number of division regions set as condensation target regions is equal to the predetermined number (in this example, four). If the number of division regions set as condensation target regions is equal to the predetermined number, the process advances to S1204; otherwise, the process advances to S1205.

In S1204 (if the number of division regions set as condensation target regions is equal to the predetermined number), the condensation count value is counted up.

In S1205, it is determined whether k=61, that is, it is determined whether S1103 and S1104 have been performed for all of the first to 61st division regions. If k=61, this flowchart ends; otherwise, the process advances to S1206. If k=61, the number of division regions set as condensation target regions is acquired in S1202 with respect to the 61st to 64th division regions, it can be said that determination for all the division regions is complete, and thus this flowchart ends when k=61.

In S1206, k=k+1 is set (k is incremented), that is, the next division region is selected. Then, the process returns to S1202.

In this embodiment in which the third to sixth division regions are set as condensation target regions, when k=3, it is determined that the predetermined number (in this example, four) of condensation target regions continuously exist in the Y direction, as shown in FIG. 11B. Therefore, the condensation count value is counted up for the third division region.

According to this flowchart, when the predetermined number (in this example, four) of condensation target regions continuously exist in the Y direction, the condensation count value is counted up. Therefore, it is possible to calculate the possibility of generation of condensation by considering that air with 100% humidity may be diffused to an adjacent division region. In this embodiment as well, it is possible to determine, based on the thus acquired condensation count value, whether it is necessary to execute cleaning.

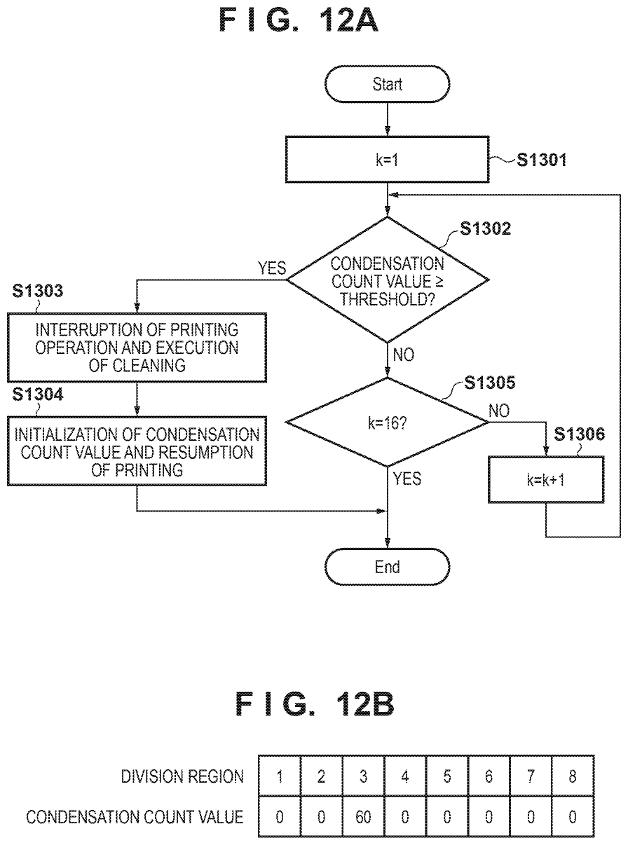

FIG. 12A is a flowchart illustrating an example of a method of determining whether it is necessary to execute cleaning. FIG. 12B shows, as an example, the condensation count value in a case where printing in which the dot count value exceeds the threshold is continued for 60 min for the third to sixth division regions, in which the condensation count value of the third division region is 60.

S1301 to S1306 of this flowchart are the same as S1001 to S1006 of the flowchart shown in FIG. 9A, respectively. Note that in S1305, it is determined whether k=61.

According to this embodiment as well, the same effect as in the first embodiment is obtained. Furthermore, according to this embodiment, even if the region of high-duty printing is located across the division regions, it is possible to appropriately detect the possibility of generation of condensation and cleaning is executed before condensation is generated, thereby making it possible to maintain printing quality more appropriately.

### Third Embodiment

The first embodiment has focused on one color ink (the same applies to the second embodiment), but there are typically differences in physical properties among various types of liquids (Y, M, C, Bk, and P). Therefore, in this case, a cleaning execution condition is set in consideration of the differences in physical properties.

By earnest examinations of the present inventor, it is found that in a case where high-duty printing is performed continuously for five types of liquids of Y, M, C, Bk, and P, condensation may be generated on the discharge surface of any of the printheads, but deterioration in printing quality is confirmed only for Bk. It is considered that this is caused by the dynamic surface tension of Bk different from those of the remaining liquids (Y, M, C, and P). To cope with this, the component of Bk can be changed so that the dynamic surface tension of Bk becomes equivalent to those of the remaining liquids, but the change of the component may make it difficult to maintain printing quality.

Thus, in this embodiment, for Bk, 1.7×10⁸ is set as a threshold for dot counting (see S903 of FIG. 8B) like the first embodiment.

On the other hand, for the remaining liquids, a value that is not exceeded even if high-duty printing is continued, for example, 3.5×10⁸ is set as a threshold.

Dot counting according to this embodiment is performed like FIG. 10B. For example, in S1103, for each of the five types of liquids, it is determined whether the dot count value of each division region exceeds the threshold (that is, 1.7×10⁸ for Bk or 3.5×10⁸ for the remaining liquids).

According to this embodiment as well, the same effect as in the first and second embodiments is obtained. Furthermore, since cleaning is not unnecessarily performed for the remaining liquids (Y, M, C, and P) for which printing quality does not deteriorate due to condensation and the printing operation is not interrupted unnecessarily, it is more advantageous in reducing the downtime of this printing apparatus.

This embodiment has exemplified the form in which the threshold for dot counting is set for each of various types of liquids. As another embodiment, the threshold for condensation counting (see S1002 of FIG. 9A) may be set for each of various types of liquids. For example, as the threshold for condensation counting, 60 may be set for Bk (like the first embodiment), and a value (for example, 180) that is not exceeded by the condensation count value may be set for the remaining liquids. Note that these two kinds of thresholds may be distinguished and expressed as the first threshold and the second threshold, or may be distinguished by expressing one of the thresholds as a standard value, a reference value, or the like.

### [Program]

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

### [Others]

In the embodiments, each element is named using an expression based on its main function. However, each function described in the embodiments may be a sub-function, and is not strictly limited to the expression. The expression can be replaced with another similar expression. In the same vein, expressions of “apparatus”, “unit”, “module”, and the like can be mutually replaced, omitted, or added.

In addition, two or more elements selectably exemplified in the embodiments are not strictly limited to the exemplification, and may arbitrarily be combined. For example, each of the two or more elements exemplified may be additionally selected or alternatively selected. As an example, when arbitrarily combining two elements A and B, to indicate one of “only A”, “only B”, and “both A and B”, an expression “A and/or B” may be used, or an expression “at least one of A and B” may be used.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-056417, filed Mar. 28, 2025, which is hereby incorporated by reference herein in its entirety.

What is claimed is:

1. A printing apparatus comprising:
a printhead configured to execute printing by discharging ink from a discharge surface;
a cleaning portion configured to clean the discharge surface; and
a control portion,
wherein the control portion includes
a determination unit configured to determine, for every predetermined time during execution of the printing by the printhead, for each of a plurality of regions divided in one direction on the discharge surface, whether the number of times of ink discharge within the predetermined time exceeds a first threshold,
a count unit configured to count, for each of the plurality of divided regions, the number of times the number of times of ink discharge within the predetermined time exceeds the first threshold, and
an execution unit configured to, in a case where a count value of the count unit reaches a second threshold with respect to any of the plurality of divided regions, interrupt the printing by the printhead and cause the cleaning portion to execute the cleaning.

2. The apparatus according to claim 1, wherein in a case where among the plurality of divided regions, a predetermined number of regions in which the number of times of ink discharge within the predetermined time exceeds the first threshold continuously exist in the one direction, the count unit counts up the count value.

3. The apparatus according to claim 1, wherein the printhead is one of a plurality of printheads configured to discharge a plurality of types of inks, respectively, and the first threshold is set based on an ink type.

4. The apparatus according to claim 3, wherein
the plurality of types of inks include at least black ink, and
the first threshold for the black ink is set to a value lower than the first threshold set for another ink.

5. The apparatus according to claim 1, wherein the printhead is one of a plurality of printheads configured to discharge a plurality of types of inks, respectively, and the second threshold is set based on an ink type.

6. The apparatus according to claim 5, wherein
the plurality of types of inks include at least black ink, and
the second threshold for the black ink is set to a value lower than the second threshold set for another ink.

7. The apparatus according to claim 1, wherein the cleaning portion includes a wiper mechanism configured to wipe the discharge surface.

8. The apparatus according to claim 1, wherein the cleaning portion includes a suction mechanism configured to perform negative pressure suction on the discharge surface.

9. The apparatus according to claim 1, further comprising a conveyance mechanism configured to convey a print medium,
wherein the one direction is orthogonal to a conveyance direction of the print medium.

10. The apparatus according to claim 9, wherein the printhead is a line head extending in the one direction.

11. A control method for a printing apparatus including a printhead configured to execute printing by discharging ink from a discharge surface and a cleaning portion configured to clean the discharge surface, comprising:
determining, for every predetermined time during execution of the printing by the printhead, for each of a plurality of regions divided in one direction on the discharge surface, whether the number of times of ink discharge within the predetermined time exceeds a first threshold,
counting, for each of the plurality of divided regions, the number of times the number of times of ink discharge within the predetermined time exceeds the first threshold, and
interrupting the printing by the printhead and causing the cleaning portion to execute the cleaning in a case where a count value in the counting reaches a second threshold with respect to any of the plurality of divided regions.

12. A non-transitory computer-readable storage medium storing a program, the program configured to cause a computer to execute each step of the control method according to claim 11.
